(19) United States
(12) Patent Application Publication
(10) Pub. No.: US 2005/0096831 A1
(43) Pub. Date: May 5, 2005

(54) Apparatus and method for the detection of objects

(76) Inventor: Graham Turnbull, South Shields (GB)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/698,987

(22) Filed: Oct. 31, 2003

(51) Int. Cl. G05D 1/00; G06F 7/00

(52) U.S. Cl. 701/96; 701/301

(57) ABSTRACT

An apparatus and method of operating the same for detecting obstacles includes an antenna having of a single metallic element, a microprocessor, a computer program, a transceiver for transmitting an oscillating digital electronic signal to the antenna and generating a feedback signal of the electronic signal in the antenna, the transmitted electronic signal generating an electromagnetic field around the antenna, the voltage and frequency of the oscillating digital electronic signal being controlled by the microprocessor according to the computer program, obstacles being detected by the transceiver monitoring change in the electronic signal passing through the antenna, and a signaling means outputs a signal upon detection by the transceiver of said change in the electronic signal passing through the antenna.

### BACKGROUND OF THE INVENTION

This invention relates to apparatus and methods for detecting objects and, in particular, to such apparatus and methods using electromagnetic radiation.

There are many circumstances in which it is desirable to be able to detect the presence of objects. In some systems, the sensor is static, and the detected object moves relative to the sensor. For example, in security systems, infrared or magnetic field sensors are used in connection with lighting to cause lights to illuminate when movement of an object is detected in a certain area, such as a mass in the area breaking the field. Also, infrared sensors are used to detect the presence of an object in order to open doors or gates. Other examples where sensors detect the presence of an object are in the operation of soap dispensers, taps, hand drying machines, and lavatories, where the detection of a hand or a body by an optical sensors operates the device.

In other systems the sensor is attached to a moving object, the purpose of the sensor being is to detect obstacles in the path of the moving object. For example, it is now relatively common to equip vehicles with sensors that can detect objects in the vehicle's path. In the case of cars, the provision of such sensors is particularly useful for parking, as the sensor provides an alarm signal when the vehicle is closer to an obstacle than a predetermined threshold distance. The obstacle may be another vehicle, which would be visible to the driver of the vehicle being parked, or an unseen obstacle, such as a high curb, or a bollard. Detectors for detecting obstacles are also used on robotic vehicles, where they provide information about the surroundings in which the robotic vehicle is located.

Many devices for detecting objects are known from the prior art. One known device is described in European Patent No. 626,072, entitled “Electromagnetic Detection System for Parking Operation”. This patent describes a device for detecting obstacles in the parking of a vehicle and comprises a transmitter and a receiver, both of which operate at radio frequency. The transmitter transmits a radio frequency signal through a transmitter antenna, and the transmitted signal is received through a receiving antenna. The presence of an object in the near field of the transmitted signal causes a perturbation thereof, e.g., the amplitude of the transmitted signal changes. This change in amplitude is detected by the receiver.

Another patent, U.S. Pat. No. 4,803,488, entitled “Driver Alerting Device”, describes a device that operates by microwave radar using the Doppler shift principle to detect the presence of a moving target.

Another patent, U.S. Pat. No. 5,087,918, entitled “FMCW/2FD Implementation for Vehicle Near Obstacle Detection System”, describes a system that operates by either frequency modulated continuous wave signals or two-frequency Doppler signals. The system detects obstacles in the path of the vehicle to which it is attached.

An object of the present invention is to provide an improved apparatus and method for detecting objects.

### SUMMARY OF THE INVENTION

The invention provides an apparatus for detecting obstacles as specified in Claim 1. Preferred features of the invention are specified in the Claims dependent on Claim 1. Another aspect of the invention provides a method of detecting obstacles as specified in Claim 11.

The apparatus and method of the invention provide for the detection of obstacles, either of moving objects approaching a stationery obstacle or a stationery obstacle being approached by a moving object. The apparatus of the invention includes a transceiver that transmits an oscillating digital electronic signal through an antenna and generates a feed back signal of the voltage in the antenna. A signal processing circuit uses the antenna feed back signal as an input and generates an output, such as an alarm signal, when the antenna feedback signal changes by a certain amount. The generation of the output signal is determined by a computer program that operates a micro-controller of the signal processing circuit. The invention also relates to a vehicle equipped with a detection apparatus of the type described above. The antenna may be mounted on a rear or front fender of a vehicle, where it is used to detect obstacles, such as curb stones, bollards, parked cars, etc. The apparatus of the invention may also be employed to open doors of buildings, where a person walking towards the door causes a change in the magnetic field around the antenna.

Various objects and advantages of this invention will become apparent to those skilled in the art from the following detailed description of the preferred embodiments, when read in light of the accompanying drawings.

### BRIEF DESCRIPTION OF THE DRAWINGS

FIG. 1 is a block diagram of a detection apparatus in accordance with this invention.

FIG. 2a is a schematic side view of a rear end of a vehicle equipped with a detection apparatus according to a first embodiment of the invention.

FIG. 2b is a plan view of the embodiment illustrated in FIG. 2a.

FIG. 3a is a schematic side view of a rear end of a vehicle equipped with a detection apparatus according to a second embodiment of the invention.

FIG. 3b is a plan view of the embodiment illustrated in FIG. 3a.

FIG. 4 is a schematic illustration of a building having automatic doors equipped with a detection apparatus according to the invention.

### DETAILED DESCRIPTION OF THE PREFERRED EMBODIMENTS

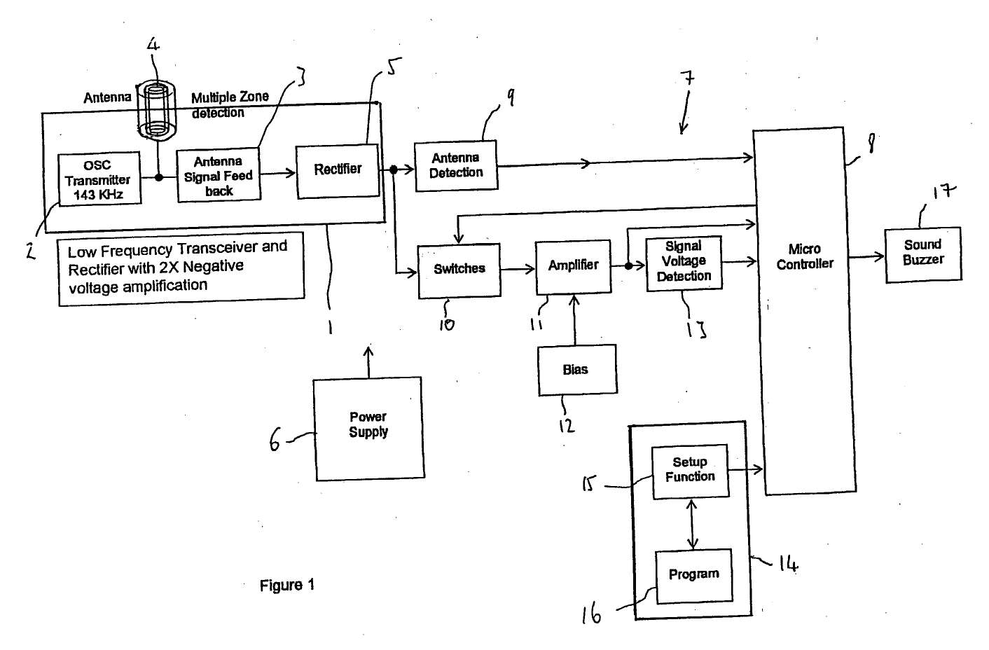

Referring now to FIG. 1, there is shown a block diagram of a detection apparatus in which a transceiver 1 is connected to a power supply 6, an antenna 4, and a signal processing circuit 7. The transceiver 1 includes a transmitter function 2, which transmits through the antenna 4 a digital electronic signal oscillating at 143 KHz at a voltage of 0.25 volts. The signal transmitted through the antenna 4 is monitored by a signal feed back receiver 3. An output signal from the signal feedback receiver 3 is rectified by a rectifier 5, the output from the rectifier 5 being an input to the signal processing circuit 7. The distance sensed can be increased by increasing the voltage and, hence, the frequency of the digital oscillating signal transmitted through the antenna 4. The antenna 4 includes a single conductive element surrounded by an insulating material, which is surrounded by a protective outer layer. The signal processing circuit 7 includes a micro-controller 8, which includes a microprocessor and a computer program. The micro-controller 8 receives a number of inputs, namely: from an antenna detection circuit 9, switches 10, an amplifier 11 which itself receives an input from a bias 12, and a signal voltage detection circuit 13. The micro-controller 8 may also receive an input from a user programming device 14, which includes a programming means 16 and a setup function circuit 15, the output of which is the input to the micro-controller 8.

The function of the different elements of the signal processing circuit 7 are described below. The antenna detection circuit 9 monitors the resistance in the conductive element of the antenna 4. If there is no resistance, i.e., the antenna 4 has become from the transceiver 1 or the conductive element is broken, the signal detected by the antenna detection circuit 9 changes, causing a change in the input to the micro-controller 8. The software is programmed to cause the micro-controller 8 to generate a warning, such as an audible noise.

The switches 10 also receive an input from the transceiver 1. An input to the switches 10 from the transceiver 1 is required in order for the signal processing circuit 7 to receive the rectified antenna feed back signal, which is processed by the signal processing circuit 7, and in particular the signal voltage detection circuit 13, which together with the micro-controller 8, the computer program, and other elements of the signal processing circuit 7 determines whether the an object is present in the field around the antenna 4. The purpose of the amplifier 11 is self-explanatory, in that the amplifier amplifies the input signal which it receives from the transceiver via one of the switches 10. The bias 12 comprises a bank of capacitors, its purpose being to smooth out any small fluctuations in voltage that occur on the circuit board mounting the amplifier 11.

The amplifier 11 outputs to the micro-controller 8 and the signal voltage detection circuit 13. The signal voltage detection circuit 13 monitors variations in voltage in the rectified received feed back signal, the variations in voltage being caused by objects in the magnetic field generated around the antenna 4. The software of the micro-controller 8 is programmed to calculate the distance of the antenna 4 from an object in the magnetic field from these variations in voltage, and to generate an output signal representative of the calculated distance. The software of the micro-controller 8 is also programmed with threshold values and to compare the output signal representative of calculated distance with the threshold values. The software of the micro-controller 8 is programmed to generate an alarm signal, such as to sound a buzzer 17, when a threshold value is exceeded. Where a buzzer 17 capable of generating tones of different pitch is connected to the micro-controller 8, the software is programmed to change the voltage of the output to the buzzer 17 when each threshold value is exceeded, thereby generating tones of increasing pitch as the antenna 4 moves closer to an obstacle.

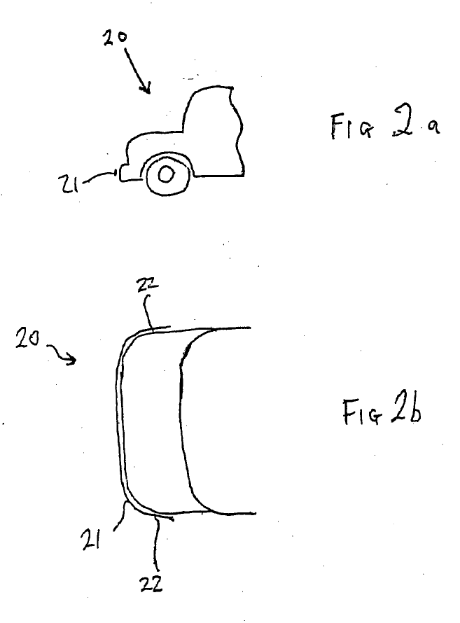

Referring now to FIGS. 2a and 2b, there is shown a rear end of a vehicle 20 that is equipped with a detection apparatus as illustrated and described with reference to FIG. 1. As can be seen from FIG. 2b, an antenna 21 is applied to the vehicle 20 so that it extends across the full width of the vehicle 20 and around edges 22 thereof.

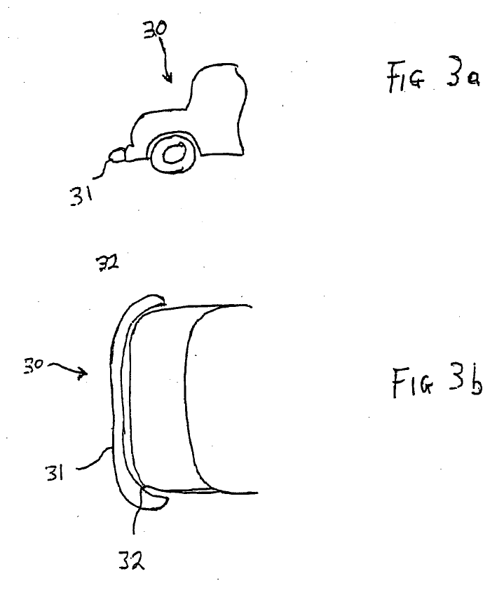

Referring now to FIGS. 3a and 3b, there is shown a rear end of a vehicle 30 that is equipped with detection apparatus as illustrated and described with reference to FIG. 1, except that the antenna 4 is replaced by the metallic fender 31 of the vehicle. As can be seen from FIG. 3b, the fender 31 extends across the full width of the vehicle 30 and around the edges 32 thereof.

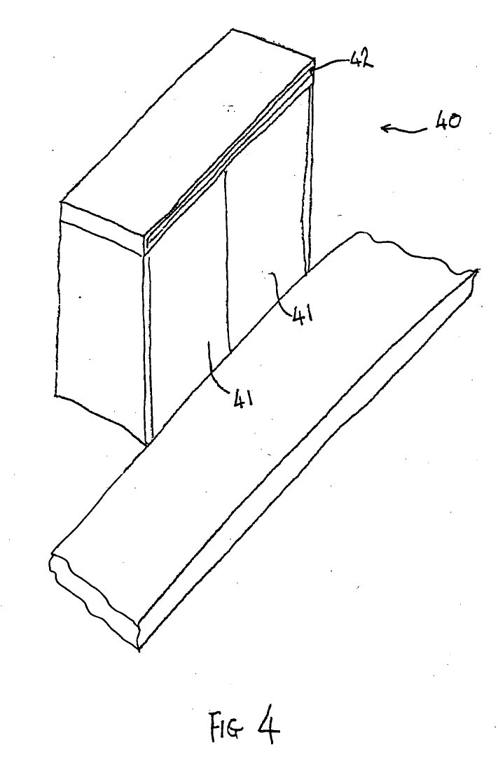

Referring now to FIG. 4, there is shown a building 40 that includes doors 41 and detection apparatus of the type shown in FIG. 1, but in place of the buzzer 17, there is an actuator (of well known type) to open the doors 41. An antenna 42 is located in close proximity to automatic doors 41. As a person walks towards the doors 41 and into the magnetic field around the antenna, a signal is sent to the actuator to open the doors 41. This arrangement is particularly useful as the distance sensed by the apparatus is up to about two meters, which means that the doors 41 are not opened simply by people walking past the sensor, as opposed to through the doors 41.

The operation of the apparatus is as follows. A digital electronic signal oscillating at 143 KHz at a voltage of 0.25 volts is continuously transmitted thorough the antenna 4, generating an oscillating magnetic field around the antenna 4. When an object enters the magnetic field, the object becomes a parameter of the generated field and causes a changes in the oscillating digital electronic signal in the antenna 4. This change is detected by the signal voltage detection circuit 13 and is processed by the micro-controller 8 to emit an output, which in the case of FIGS. 1 to 3 is a sound, and in the case of FIG. 4 is actuation of a door opening mechanism. When the object moves out of the magnetic field, the field parameters revert to the parameters due to the transmitted digital electronic signal oscillating at 143 KHz at a voltage of 0.25 volts. Hence, it can be seen that the function performed by the apparatus of the invention is one of monitoring the signal in the antenna 4, as opposed to the systems of the prior art which rely on transmitting a signal via a signal transmission means and a transmitting antenna, and then using a receiving means including a receiving antenna to receive the transmitted signal.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. An apparatus for detecting obstacles comprising:
an antenna including a single electrically conductive element;
a signal processing circuit including a microprocessor;
a computer program;
a transceiver transmitting an oscillating digital electronic signal to the antenna and generating a feedback signal of the electronic signal passing through the antenna, the transmitted electronic signal generating an electromagnetic field around the antenna, wherein the signal processing circuit has as an input the antenna feedback signal generated by the transceiver, and wherein the voltage and frequency of the oscillating digital electronic signal transmitted through the antenna is controlled by the micro-processor according to the computer program, and wherein, when an obstacle enters the generated electromagnetic field around the antenna, the antenna feedback signal changes, the change being detected by the signal processing circuit, and wherein a signaling means generates an output signal upon detection by the signal processing circuit of a change in the electronic signal passing through the antenna.

2. An apparatus according to claim 1 wherein the digital electronic signal oscillates in the radio frequency.

3. An apparatus according to claim 1 wherein the voltage of the oscillating digital electronic signal is adjustable, and wherein adjustment of said voltage adjusts the region in which obstacles can be detected.

4. An apparatus according to claim 1 wherein the antenna is a single electrically conductive element surrounded by an insulating layer of material.

5. An apparatus according to claim 1 wherein the antenna is an element of an object to which it is attached.

6. An apparatus according to claim 5 wherein the object is a metallic fender of a vehicle having a body, the fender being mounted on the body by electrically isolating mounting means.

7. An apparatus according to claim 1 wherein the output signal varies according to the magnitude of change in voltage of the electronic signal passing through the antenna, and wherein the variation in output signal is controlled by the microprocessor in accordance with the computer program.

8. An apparatus according to claim 7 wherein the computer program provides a number of discrete output signals, and wherein change from one output signal to another output signal is determined by the monitored voltage in the antenna.

9. An apparatus according to claim 1 wherein the apparatus includes an alarm device, and the output signal is received by the alarm device, the alarm device generating an alarm signal upon receipt of said output signal.

10. An apparatus according to claim 9 wherein the alarm output is an acoustic alarm.

11. An apparatus according to claim 1 wherein the digital electronic signal is transmitted at 143 KHz and 0.25 Volts.

12. A method for detecting obstacles using the apparatus of claim 1, in which the transceiver generates an oscillating digital electronic signal, transmits the said signal to an antenna, and generates a feedback signal of an electronic signal passing through the antenna, the transmitted electronic signal generating an electromagnetic field around the said antenna; and the signal processing circuit receives and processes the antenna feedback signal according to the computer program, and generates an output signal upon detection of an obstacle in the generated electromagnetic field.
